(19) United States
(12) Patent Application Publication
(10) Pub. No.: US 2014/0297908 A1
(43) Pub. Date: Oct. 2, 2014

(54) EXTENSIBLE COMMUNICATIONS NETWORK PROVIDING INDEPENDENT OR REMOTE OPERATION OR CONTROL OF ELECTRONIC SYSTEMS

(71) Applicants: Chia-Chi Teng, Provo, UT (US); Tracy W. Nelson, Springville, UT (US); Jacob D. Allred, Riverton, UT (US)

(72) Inventors: Chia-Chi Teng, Provo, UT (US); Tracy W. Nelson, Springville, UT (US); Jacob D. Allred, Riverton, UT (US)

(21) Appl. No.: 14/242,579

(22) Filed: Apr. 1, 2014

Related U.S. Application Data
(60) Provisional application No. 61/807,304, filed on Apr. 1, 2013.

(51) Int. Cl. G06F 13/38

(52) U.S. Cl. CPC G06F 13/385; G06F 2211/005
USPC 710/62

(57) ABSTRACT

An extensible system and method for providing a communication network including a central controller, a remote controlling device and a peripheral device, the central controller enabling communication between the remote controlling device and the peripheral device, the central controlling device and/or the remote controlling device having an extensible computer program, the extensible system being capable of adding additional peripheral devices, the central controller being capable of learning the communication protocols and communication standards of additional peripheral devices and the extensible control program being capable of learning how to communicate and control any peripheral devices that are connected to the central controller.

### BACKGROUND OF THE INVENTION

1. Field of the Invention

This invention relates generally to an extensible communications network. More specifically, the present invention is a system that enables a central controller to create an ad-hoc network and provide communication between a controlling device and a peripheral device, the system being adaptable to add additional peripheral devices that may be integrated by the central controller into the system.

2. Description of Related Art

Proprietary systems exist for electronic systems that provide many services. Some systems that are particularly relevant to the invention include, but should not be considered limited to, electronic game call systems, security systems and remote monitoring systems. These and other similar systems may provide a central controller that communicates with peripheral devices, or they may be standalone peripheral devices.

For example consider a security system. A central controller may communicate with remote sensors such as motion sensors, door sensors and window sensors. These remote sensors send signals to the central controller when they are triggered by motion or the opening or closing of a door or window. Communication between the central controller and the various sensors may take place using a proprietary communication protocol that is unique to them. Furthermore, control of the central controller and the various sensors may only be possible using the interface provided with the system.

Another example is an electronic game call system. A game call system may include a central system that controls operation of game call generators, game cameras and game decoys. The game call system may be turned on and off, or generate a call specified by a proprietary remote device in order to attract game to specific locations for study or for sport.

A feature that may be common to most of the systems is that they may use proprietary communication protocols. The use of proprietary communication protocols prevents peripheral devices of one system from being used with a central controller of another system because they can't communicate.

Another feature of the systems may be that the user has little or no control over a specific component other than what is provided by the interface that comes with a proprietary system. Users may have more technical ability than in the past and therefore may want more control or the ability to customize the function of a peripheral device or even an interface to the peripheral device in order to provide the features that are believed to be needed.

Another feature of these systems is that they may provide a very limited but desirable function. For example, a game call system may operate specifically for one type of game animal. Therefore, a completely different but often duplicative system may be needed in order to provide the ability to attract a different game animal. For example, a game call generator may store recorded sounds of one game animal. Unfortunately, it may be necessary to provide a different game call generator to attract another game animal. Similarly, the game cameras of one game call system may not be compatible with another game call system because they communicate using proprietary communication protocols. So instead of being able to expand camera coverage of an area by controlling the game call cameras with a single interface, the game cameras must be controlled by different game call systems.

It would be an advantage over the prior art to be able to combine peripheral devices from different systems for use with a single central controller. It would also be an advantage to provide a customizable interface that may be adaptable in order to communicate with peripheral systems that may not have been designed to be used with it.

### BRIEF SUMMARY OF THE INVENTION

In a preferred embodiment, the present invention is an extensible system and method for providing a communication network including a central controller, a remote controlling device and a peripheral device, the central controller enabling communication between the remote controlling device and the peripheral device, the central controlling device and/or the remote controlling device having an extensible computer program, the extensible system being capable of adding additional peripheral devices, the central controller being capable of learning the communication protocols and communication standards of additional peripheral devices and the extensible control program being capable of learning how to communicate and control any peripheral devices that are connected to the central controller.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of a first embodiment of a communication network described by the present invention.

FIG. 2 is a block diagram of a second and expanded communication network shown in FIG. 1.

FIG. 3 is a block diagram of a third communication network.

FIG. 4 is a block diagram of a fourth communication network.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

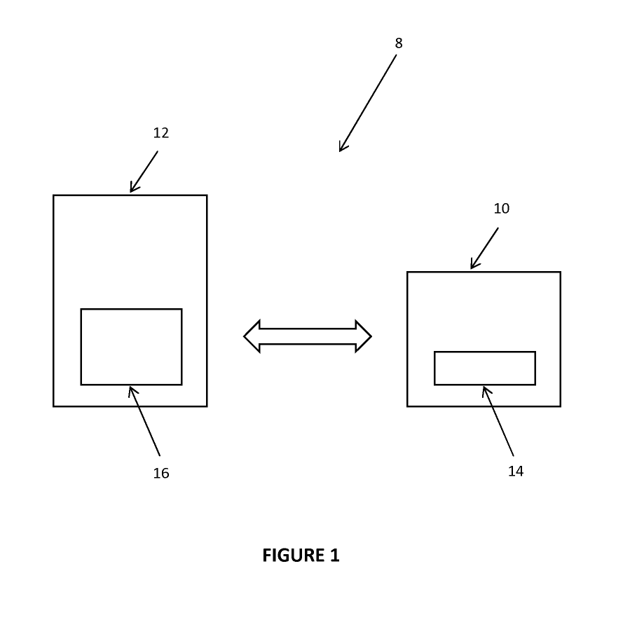

A first embodiment of the present invention is illustrated in a block diagram in FIG. 1. FIG. 1 shows a communication network 8 including a first peripheral device 10 that may perform a first function. The first function may be any function that is controllable by receiving commands from a control program running on a remote controlling device. The control program may be executed on a remote controlling device 12.

The communication network 8 may be defined as a combination of a communication system that is using a specific communication protocol. The communication system may be defined as a communication standard that is being used. Communication standards may be defined in this document as including but not being limited to various wired and wireless systems. Wireless system may include but should not be considered as limited to cellular telephone, Bluetooth, near field communication (NFC), infra-red communication, radio frequency identification (RFID) communication or wireless local area network (WLAN or WIFI) communication.

The communication protocol may be defined as a system of digital rules for data exchange using any appropriate communication system. Some well-known communication protocols for digital systems that may be considered to be included within the scope of communication protocols of the present invention may include but should not be considered as limited to IPX/SPX, AppleTalk, TCP/IP and packet protocols.

There are many examples that may be given that describe possible functions that may be performed by the first peripheral device 10. These examples are only given to illustrate the principles of the first embodiment and should not be considered as limiting of the first embodiment. For example, the first function may be a game call generator, a game camera, a game video recorder, a game decoy or any other function that may be remotely operated by a game call system.

In another example, the first function may be a motion sensor, a door sensor, a window sensor, a water sensor, a temperature sensor, a furnace control device, an air conditioning control device, a security camera, a security video recorder or any other function that may be used as part of a security system.

In another example, the first function may be any function that is controllable by a wired or wireless communication network. These other communication network systems may be considered to include but should not be limited to home automation, a remote irrigation system, a remote trapping or pest control system, an oil field monitoring system and a manufacturing system. For example, some home automation systems may include garage door controllers, window covering controllers, sprinkling controllers and lighting controllers.

One communication network that is different from those mentioned above is any system that enables two or more people to communicate within an isolated communication network. For example, the communication network may be a system that enables various smart phones, hand-held and portable two-way radio transceivers (walkie-talkies), or other similar portable communication devices, to be able to communicate when they are within range of the communication network. For example, consider a building or network of buildings such as a manufacturing plant, construction site, or even corporate offices.

In this first embodiment of the communication network 8, a central controller 14 is provided as a part of the first peripheral device 10. The central controller 14 may be made an integral component of the first peripheral device 10 such as a plurality of integrated circuits disposed on a substrate that is shared by integrated circuits of the first peripheral device. Alternatively, the central controller 14 is a separate device that may share power and/or a housing with the first peripheral device 10. The central controller 14 may be removable from the first peripheral device 10 or it may be an integral component.

The central controller 14 may enable communication between an extensible interface on the remote controlling device 12 and the first function performed by the first peripheral device 10 in order to create the communication network 8. Communication between the remote controlling device 12 and the first peripheral device 10 may take place because each device may have been manufactured to work together. Thus, the communication protocols and the communication systems are intended to work together.

However, in the alternative, the communication protocols and/or the communication systems of the communication network 8 being used by the devices 10, 12 may be proprietary or incompatible. In other words, the devices 10, 12 may not have been designed to operate with each other. An aspect of the first embodiment is that the devices 10, 12 may or may not have been designed to communicate on a same type of communication network. When the devices 10, 12 are designed to communicate, then the central controller 14 may act as a pass-through device. However, when the devices 10, 12 are not designed to communicate on a same type of communication network, the first embodiment may provide a unique feature. Specifically, the first embodiment may include a central controller 14 that enables the first peripheral device 10 and the remote controlling device 12 to communicate using a communication network 8 that uses the appropriate communication protocols and communication systems.

To make communication possible, the central controller 14 of the communication network 8 may have to perform several tasks. For example, the central controller 14 may have to translate between different communication protocols. The central controller 14 may be capable of receiving data in one digital format or using one communication protocol and transmit the data using a different communication protocol. It should be understood that those skilled in the art understand how to perform this function and therefore the act of translation is considered to be understood by those skilled in the art of data translation. What may be novel is the ability of the central controller 14 to perform this task in the context of the first embodiment.

Another task that the central controller 14 may need to perform is to receive data using a first communication system and to transmit the data using a second or different communication system. For example, the central controller 14 may receive data that is transmitted using a wireless communication system such as Bluetooth, and then transmit data using a different wireless communication system such as WiFi or a wired communication system.

It should be understood that those skilled in the art understand how to perform this function and therefore the act of receiving data using one communication system and then transmitting the data using a different communication system is considered to be understood by those skilled in the art of data translation. What may be novel is the ability of the central controller 14 to perform this task in the context of the first embodiment.

Another task that the central controller 14 may need to perform in the first embodiment is to recognize which communication protocol and/or which communication system is being used by the first peripheral device 10 and the remote controlling device 12. Before the central controller 14 may translate between communication protocols and communication systems, the central controller 14 may need the ability to recognize what is being used without being provided with information regarding which communication protocols and which communication systems are being used by the first peripheral device 10 and the remote controlling device 12 in order to perform the function of enabling communication.

Alternatively, the central controller 14 may only need to be told which communication protocols and which communication systems are being used in order to enable communication between them.

Alternatively, the communication protocols and which communication systems are being used by the first peripheral device 10 may be unknown. In an alternative embodiment, the central controller 14 may be capable of monitoring signals from the first peripheral device 10. From the signals generated, the central controller 14 may on its own or with assistance from a user be able to assign a meaning to the signals, and thereby learn how to control or just to receive meaningful data from the first peripheral device 10.

For example, consider a motion sensor from an unknown manufacturer. The user may cause the motion sensor to generate a signal by moving within range of the motion sensor. The central controller 14 may be capable of monitoring signals generated by the motion sensor. The user may assume that any signal generated from the motion sensor is a signal to a central controller that the motion sensor has detected motion. The central controller 14 may then categorize the signal so that it may be recognized if the signal is received at a future time.

The potential of this alternative embodiment is that proprietary peripheral devices that send signals whose purpose can be determined may still be useful. The signals may eventually be learned by the central controller 14 and therefore be usable by a system for which the proprietary peripheral devices were not designed.

The remote controlling device 12 may be any portable or stationary device that is capable of executing a program in software or firmware. The portable device may be selected from such portable devices as a mobile telephone, a smart phone, a tablet computer, or a laptop, but should not be considered limited to these devices. The portable device should be any portable device that is capable of executing the control program and of communicating with the central controller 14.

A stationary device may be selected from such devices as a desktop computer or a kiosk, but should not be considered as limited to these devices. The stationary device should also be any stationary device that is capable of executing a control program 16 and of communicating with the central controller 14.

The program may be an extensible control program 16 that may enable functions or capabilities to be added to the communication network 8. The purpose of the extensible control program 16 on the remote controlling device is to provide a user with an interface for controlling the function of the first peripheral device 10.

For example, if the first peripheral device 10 is a game call generator, it may include one or more recordings of game animals that may be used to attract game. The remote controlling device 12 may be operated by a user who is concealed in a location where the game call generator may be observed.

The extensible control program 16 on the remote controlling device 12 may provide various functions to the user. For example, the user may be able to cause the game call generator to generate a first sound, a second sound or a third sound at the press of a button on the remote controlling device 12.

The remote controlling device 12 and the extensible control program 16 may also be able to provide functionality that the game call generator does not provide. For example, the timing of sounds produced by the game call generator may not be a feature provided by an interface from the manufacturer. The first embodiment may provide the ability to provide new functions or features by providing those new functions of feature in the extensible control program 16. For example, the extensible control program 16 may produce a precise sequence of recorded sounds at precise intervals. This is only an example of the new functionality that may be provided by the extensible control program 16 of the first embodiment, and should not be considered as limiting of the new functions or features that may be provided. This new system may also enable control of multiple functions or devices independently or simultaneously.

The first embodiment of the present invention creates more than just an ad-hoc network for the communication network 8 that might only be capable of using proprietary devices that are designed to work with the network. The present invention is more versatile because it may provide the ability to adapt the communication network 8 using the central controller 14 so that incompatible peripheral devices may be able to be used on the same communication system. Furthermore, by providing an extensible control program 16, new or enhanced functions may be added to the communication network 8.

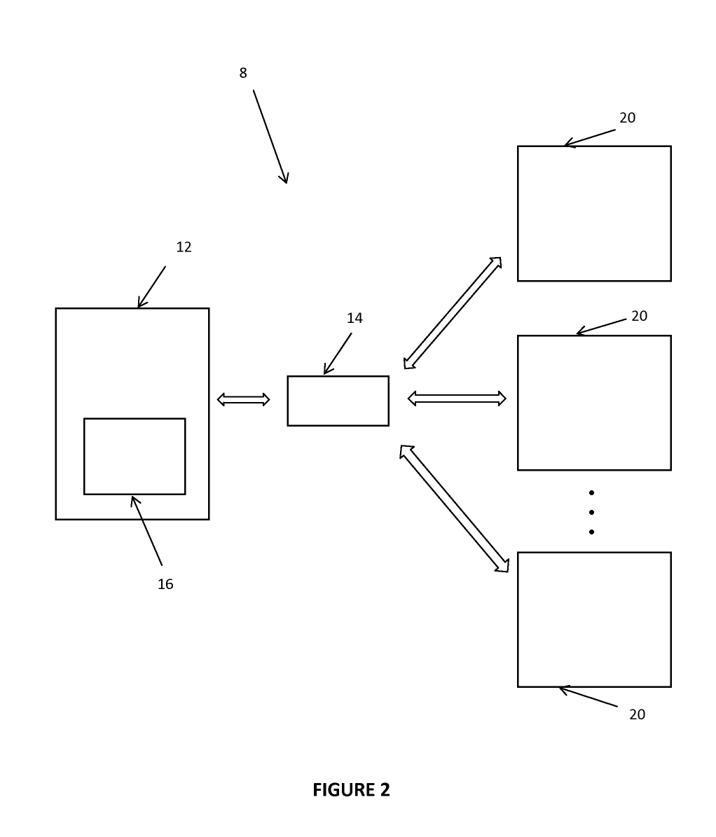

FIG. 2 is a block diagram of an expanded communication network 8. This communication network 8 is modified to include a plurality of peripheral devices 20. The functions of the peripheral devices 20 include all those described above and any others that may be suitable for a communications system 8.

One difference in this second embodiment shown in FIG. 2 is that because the central controller 14 does not need to be disposed on or within one of the peripheral devices 20, the central controller is shown as an independent or standalone device. Nevertheless, the central controller 14 may always be provided in a peripheral device 20.

If a user wants to add a peripheral device 20 to the existing communication network 8, the system must be capable of expansion. For example, consider the communication network 8 to be a game call system. The user is adding a peripheral device 20 that is not designed for the existing game call system. For example, the peripheral device 20 may be a new remote camera that is only available for use with a different game call system or was not yet manufactured when the game call system was first sold. Accordingly, the remote camera may not be capable of being controlled by an existing control program.

In this second embodiment, the extensible control program 16 on the remote controlling device 12 may be modified in order to be able to control the new peripheral device 20. The first way that this may be accomplished is that the extensible control program 16 may communicate over a network, such as the Internet, and locate specifications for the peripheral device 20. The specifications may indicate the signals that may be sent to the device and received from the device. The specifications or signal information may be uploaded to the extensible control program 16. Alternatively, the specifications may be located and then the information may be manually entered into the extensible control program 16.

Once the signal information is loaded into the extensible control program 16 by upload or manual data entry, the extensible control program may be used to send control signals and to receive data from the peripheral device 20. Thus, the new remote camera may be added to the communication network 8 and be operated and controlled by the extensible control program 16.

In this way, new peripheral devices may be added, old devices may be added, incompatible devices may be added, and new functionality or control of the peripheral devices may be added to the communication network 8. The extensible control program 16 is capable of being adapted to control new devices, and the central controller 14 is capable of communicating with peripheral devices that were not specifically designed to for use with the central controller.

One aspect of the invention that may be applied to all embodiments is that the remote controlling device 12 and the peripheral devices 10, 20 may use different communication systems depending on the distance that they are located from the devices they are using to communicate. For example, the remote controlling device 12 may use one communication system when it is relatively near the first peripheral device 10, but it may use a different communication system when far removed. For example, the remote controlling device 10 may use Bluetooth when separate from the central controller 14 by 30 feet, but it may use a WIFI communication system up to hundreds of feet, and RF or GSM when located at greater distances.

Another aspect of the invention is that there may be intervening devices that function to pass along control commands or other signals between the various devices. For example, the remote controlling device 12 may be miles from the central controller 14. The remote controlling device 12 may send a signal that is transmitted to the Internet. The signal may then travel over the Internet to a wireless modem to be broadcast from the wireless modem that is located much nearer to the central controller 14.

In another alternative embodiment, there may be more than one central controller 14. Furthermore the plurality of central controllers 14 may be dispersed among some or all of the peripheral devices 20 and be provided as standalone devices. Therefore, the communication network 8 may have a plurality of central controllers 14 that do not interfere with operation of the communication system.

The second embodiment shown in FIG. 2 may also be modified in a third embodiment. The second embodiment shows the extensible control program 16 operating on the remote controlling device 12.

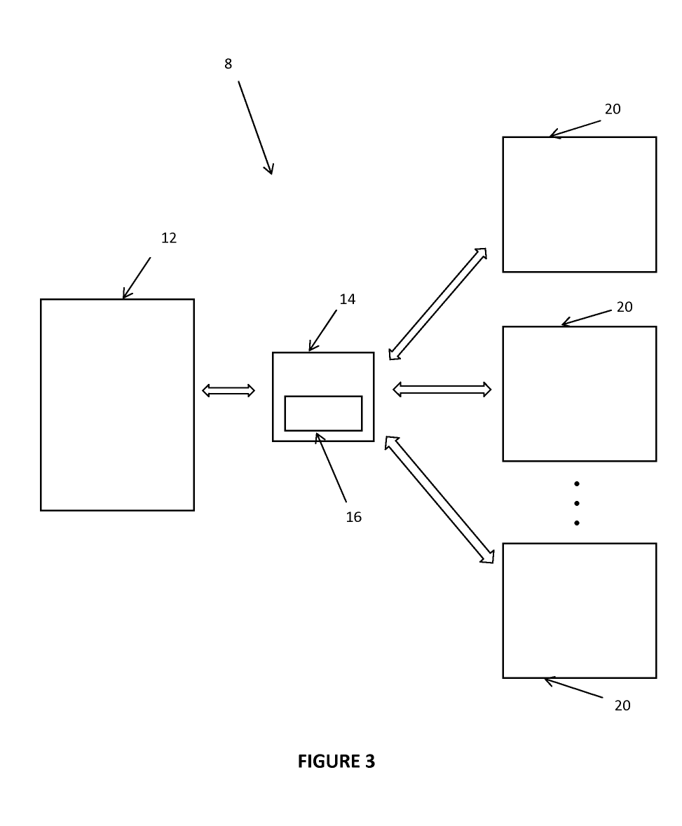

In the third embodiment shown in FIG. 3, the extensible control program 16 is operating on the central controller 14. The remote controlling device 12 accesses the extensible control program 16 on the central controller 14 through any convenient interface such as a web browser or a proprietary program that may be installed on each remote controlling device 12. The communication network 8 may enable the remote controlling device 12 to communicate with the plurality of peripheral devices 20 through the extensible control program 16 that is now running on the central controller 14.

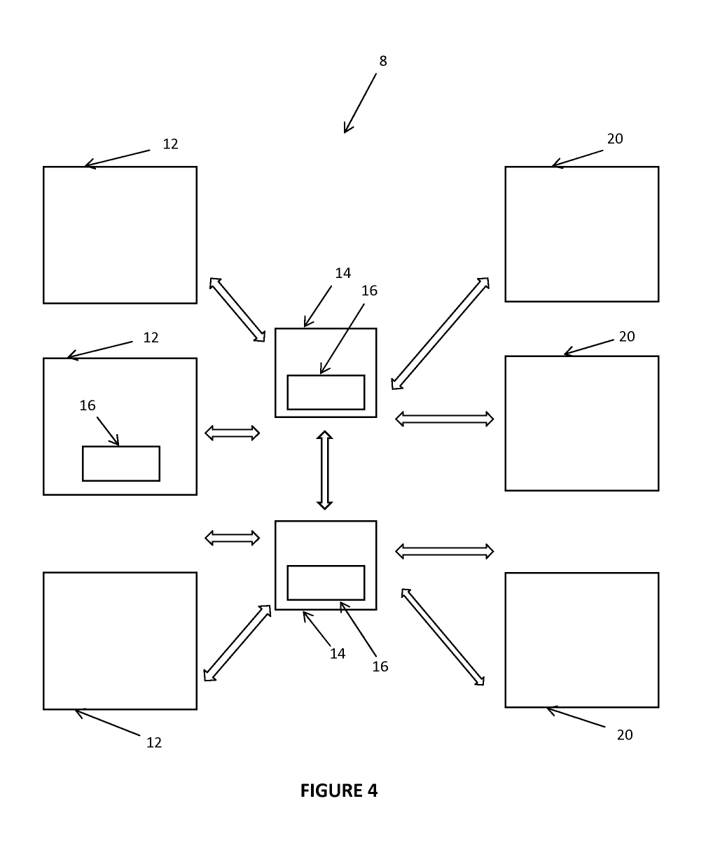

FIG. 4 is provided as a fourth embodiment of the present invention. It was explained previously that the communication network 8 may enable two or more people to communicate within an isolated communication network. The example was for a system that may enable two or more people to communicate on smart phones or walkie-talkies. The fourth embodiment presents several advantages. First, there may be more than one remote control device 12 in operation at the same time. For example, one user may be monitoring or controlling machinery, while a second person is monitoring or controlling different machinery. Both users may be using the same central controller 14. However, in this embodiment, the users may be far apart. Therefore, there may be a plurality of central controllers 14. The central controllers 14 may communicate with each other via a cellular or WiFi network.

Another advantage is that the users may have remote control devices 12 that do not typically communicate with each other. For example, one user may have a walkie-talkie that uses radio to communicate. Another user may have a smart phone. The central controllers 14 may enable the remote control devices 12 to communicate with each other as well as with the plurality of peripheral devices 20.

Accordingly, the central controllers 14 may not only enable communication from a remote control device 12 to a peripheral device 20 and vice versa, but they may also enable peripheral devices 20 to communicate with each and for remote control devices 12 to communicate with each other. The communication may be voice or any other type of data. It should also be understood that the extensible control program 16 may be disposed in the remote controlling device 12, the central controller 14 or both.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for communicating with peripheral devices on a single communication network, said method comprised of:
providing at least one peripheral device on a communication network, providing a remote controlling device for communicating with the at least one peripheral device, and providing a central controller for enabling communication between the at least one peripheral device and the remote controlling device;
communicating between the central controller and the at least one peripheral device using a first communication system and a first communication protocol that are used by the at least one peripheral device;
communicating between the central controller and the remote controlling device using a second communication system and a second communication protocol that are used by the remote controlling device and which may be different from the first communication system and the first communication protocol; and
wherein the central controller is capable of communication using a plurality of different communication systems and communication protocols.

2. The communication network as defined in claim 1 wherein the system further comprises:
providing a second peripheral device that communicates using a third communication system and a third communication protocol; and
communicating between the central controller and the second peripheral device using a communication standard and a communication protocol that may be different from the second communication network.

3. The communication network as defined in claim 1 wherein the system further comprises:
providing an extensible control program on the remote controlling device;
adding a second peripheral device to the communication network;
adding data to the extensible control program control the second peripheral device, wherein the extensible control program may now control the second peripheral device.

4. The communication network as defined in claim 3 wherein the system further comprises receiving input at the central controller to enable communication between the central controller and the second peripheral device.

5. The communication network as defined in claim 3 wherein the system further comprises receiving input at the remote controlling device to enable communication between the central controller and the second peripheral device.

6. The communication network as defined in claim 5 wherein the system further comprises receiving input to the extensible control program to enable communication between the central controller and the second peripheral device.

7. The communication network as defined in claim 6 wherein the system further comprises entering data regarding commands that are accepted by the second peripheral into the extensible control program to enable the extensible control program to communicate with the second peripheral device.

8. The communication network as defined in claim 1 wherein the system further comprises isolating the communication network from all other communication networks such that the communication network is operating independently.

9. The communication network as defined in claim 1 wherein the system further comprises selecting the at least one peripheral device from the group of peripheral devices that may be used with a game call system, a security system, a home automation system, a remote irrigation system, a remote trapping or pest control system, an oil field monitoring system and a manufacturing system.

10. The communication network as defined in claim 1 wherein the system further comprises selecting the at least one peripheral device from the group of peripheral devices comprised of game call generators, game cameras, game decoys, motion sensors, door sensors, window sensors, water sensors, temperature sensors, a furnace control device, an air conditioning control device, security cameras, security video recorders, garage door controllers, window covering controllers, sprinkling controllers and lighting controllers.

11. The communication network as defined in claim 1 wherein the system further comprises providing an extensible control program on the central controller.

12. The communication network as defined in claim 1 wherein the system further comprises providing a plurality of remote controlling devices.

13. The communication network as defined in claim 1 wherein the system further comprises providing a plurality of peripheral devices.

14. The communication network as defined in claim 1 wherein the system further comprises providing a plurality of central controllers.

15. The communication network as defined in claim 15 wherein the system further comprises providing an extensible control program on at least one of the plurality of central controllers.

16. The communication network as defined in claim 1 wherein the method further comprises:
transmitting at least one control signal from the remote controlling device to the central controller; and
transmitting the at least one control signal from the central controller to the at least one peripheral device.

17. The communication network as defined in claim 16 wherein the method further comprises
transmitting at least one signal from the at least one peripheral device to the central controller; and
transmitting the at least one signal from the central controller to the remote controlling device.

18. A method for communicating with peripheral devices on a communication network, said method comprised of:
providing at least one peripheral device on a communication network, providing a remote controlling device for communicating with the at least one peripheral device, and providing a central controller for enabling communication between the at least one peripheral device and the remote controlling device;
communicating between the central controller and the at least one peripheral device using a first communication system and a first communication protocol that are used by the at least one peripheral device;
communicating between the central controller and the remote controlling device using a second communication system and a second communication protocol that are used by the remote controlling device and which may be different from the first communication system and the first communication protocol; and
providing an extensible control program on the remote controlling device that enables the extensible program to add information in order to communicate with other peripheral devices that may be added to the communication network.

19. A communication network for communicating with peripheral devices on a communication network, said communication network comprised of:
at least one peripheral device;
a remote controlling device for sending and receiving signals to control the at least one peripheral device, and for running at least one program; and
a central controller for enabling communication between the at least one peripheral device and the remote controlling device, wherein the central controller is capable of translating between a plurality of different communication systems and communication protocols.

20. The communication network as defined in claim 19 wherein the communication network is further comprised of an extensible control program that is run on the remote controlling device and which is capable of being modified by adding data regarding peripheral devices so that control signals may be sent to the at least one peripheral device.

21. A communication network for communicating with peripheral devices on a communication network, said communication network comprised of:
at least one peripheral device;
a remote controlling device for sending and receiving signals to control the at least one peripheral device, and for running at least one program;
a central controller for enabling communication between the at least one peripheral device and the remote controlling device; and
an extensible control program that is run on the remote controlling device and which is capable of being modified by adding data regarding different peripheral devices so that control signals may be sent to the at least one peripheral device.
